(19) United States
(12) Patent Application Publication
(10) Pub. No.: US 2005/0086390 A1
(43) Pub. Date: Apr. 21, 2005

(54) Efficient packet desegmentation on a network adapter

(75) Inventors: Dwip N. Banerjee, Austin, TX (US); Kavitha Vittal Murthy Baratakke, Austin, TX (US); Vinit Jain, Austin, TX (US); Venkat Venkatsubra, Austin, TX (US)

Correspondence Address: IBM CORP (AP);C/O AMY PATTILLO, P. O. BOX 161327, AUSTIN, TX, 78716, US

(73) Assignee: International Business Machines Corporation, Armonk, NY (US)

(21) Appl. No.: 10/687,235

(22) Filed: Oct. 16, 2003

(51) Int. Cl. G06F 15/16; G06F 13/42

(52) U.S. Cl. 709/250; 710/105

(57) ABSTRACT

A method, system, and program for efficient packet desegmentation on a network adapter are provided. Multiple data packet segments received at a network adapter from a single connection are buffered at the network adapter. The single connection is identified by addresses and ports extracted from the header of each data packet segment. Responsive to detecting a buffering release condition, the data packet segments are released from the network adapter as a desegmented group to a network stack, such that the data packets segments received for the single connection are efficiently passed to the network stack together. In particular, the single connection is a TCP connection identified by a four-tuple of source and destination addresses and ports extracted from each TCP header of each of said plurality of data packet segments.

### BACKGROUND OF THE INVENTION

1. Technical Field

The present invention relates in general to improved networking and in particular to a method for efficiently desegmenting packets on a network adapter. Still more particularly, the present invention relates to buffering multiple packets from the same network connection at a network adapter before the multiple packets are sent as a single desegmented group to the network stack.

2. Description of the Related Art

The development of computerized information resources, such as interconnection of computer networks, allows users of data processing systems to link with servers within a network to access vast amounts of electronic information. Multiple types of computer networks have been developed that provide different types of security and access and operate at different speeds. For example, the internet, also referred to as an “internetwork”, is a set of computer networks, possibly dissimilar, joined together by means of gateways that handle data transfer and the conversion of messages from the sending network to the protocols used by the receiving network. When capitalized, the term “Internet” refers to the collection of networks and gateways that use the TCP/IP suite of protocols.

Server systems connected to the Internet provide data and processing resources to client systems connected to the Internet. Server systems often receive requests from multiple client systems at the same time. Further, server systems often receive high large volumes of data each millisecond. There is a need to efficiently manage the processing of data received at server systems.

Server systems are typically equipped with a network adapter that provides a hardware connection between an interface to the bus system of a server system and an interface to the network connection enabling access to the Internet. A busy network adapter, such as a one gigabit Ethernet adapter, can handle packets of data arriving at a rate such as 50,000 packets per millisecond. As part of the TCP/IP protocol, data is typically broken down into segments for transmission across the Internet. A typical network adapter receives each data packet segment and immediately passes it via the bus system to network software, often termed the TCP/IP or network stack. The TCP/IP stack controls the processing of the data packets. Even though a stream of data packet segments may arrive from the same connection and could be processed together, network adapters are limited in that they pass each data packet segment individually to the TCP/IP stack. Immediately handing over individual data packets, one at a time, to the TCP/IP stack is inefficient. Further, the inefficiency multiplies when each individually received data packet segment requires a separate direct memory access for storage. Moreover, the protocol stack maintains a protocol control block (PCB) that maintains the state of each connection to the server. For each data packet segment received by the network stack, currently the PCB table is searched, reducing the efficiency of the system.

Therefore, it would be advantageous to provide a method, system, and program for improving the efficiency of busy servers by desegmenting data packets arriving at a network adapter from the same connection, so that a single desegmented group of data packets can be sent to the network stack.

### SUMMARY OF THE INVENTION

In view of the foregoing, it is therefore an object of the present invention to provide improved networking.

It is another object of the present invention to provide a method, system and program for efficiently desegmenting packets on a network adapter.

It is yet another object of the present invention to provide a method, system and program for buffering multiple packets from the same TCP connection at a network adapter before the multiple packets are sent as a single desegmented group to the network stack.

According to one aspect of the present invention, multiple data packet segments received at a network adapter from a single connection are buffered at the network adapter. The single connection is identified by address and port identifiers extracted from the header of each data packet segment. Responsive to detecting a buffering release condition, the data packet segments are released from the network adapter as a desegmented group to a network stack, such that data packets from the same connection are sent to the network stack together. In particular, the single connection is a TCP connection identified by a four-tuple of source and destination addresses and ports extracted from each TCP header of each of said plurality of data packet segments.

According to another aspect of the present invention, responsive to receiving a new data packet segment at the network adapter, the address and port identifiers for a connection across which the new data packet segment was sent are extracted. Then, responsive to the addresses and ports for the connection matching buffered addresses and ports for the single connection, adding said new data packet segment to the buffer of data packets segments received for the single connection within the network adapter. Separate queues may be maintained in the network adapter, where the data packets buffered in each individual queue are received from separate connections.

There are multiple types of buffering release conditions that may be detected. First, a buffering release condition may be detected when a new data packet segment received at the network adapter is from a different connection than the single connection. Second, a buffering release condition may be detected when the time a first received data packet segment from among said plurality of data packet segments remains within the buffer exceeds a time threshold. Third, a buffering release condition may be detected when a queue size limit in said network adapter for buffering data packet segments is reached. Fourth, a buffering release condition may be detected when an abnormal condition occurs. An abnormal condition may include at least one from among a checksum mismatch, a connection reset, an urgent pointer, and a missing packet being detected.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting a computer system in which the present method, system, and program may be implemented;

FIG. 2 is a block diagram depicting a distributed network system for transferring data packets in accordance with the method, system, and program of the present invention;

FIG. 3 is a block diagram depicting a network adapter within a networking system in accordance with the method, system, and program of the present invention;

FIG. 4 is a block diagram depicting a network adapter for desegmenting packets in accordance with the method, system, and program of the present invention; and

FIG. 5 is a high level logic flowchart depicting a process and program for for desegmenting data packets at a network adapter.

### DETAILED DESCRIPTION OF THE PREFERRED EMBODIMENT

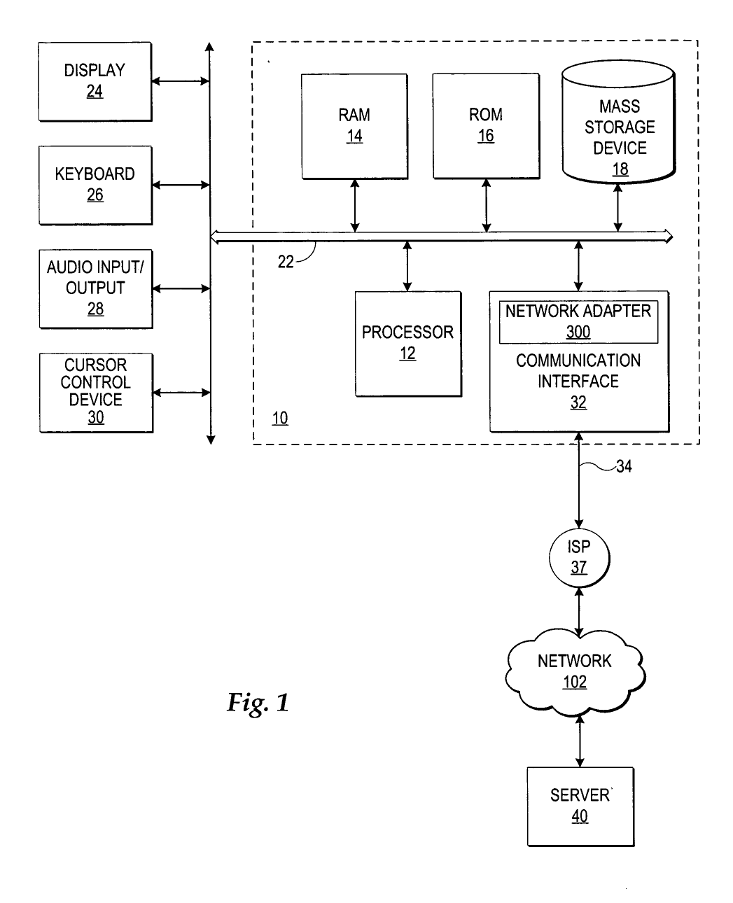

Referring now to the drawings and in particular to FIG. 1, there is depicted one embodiment of a computer system in which the present method, system, and program may be implemented. The present invention may be executed in a variety of systems, including a variety of computing systems and electronic devices under a number of different operating systems. In general, the present invention is executed in a computer system that performs computing tasks such as manipulating data in storage that is accessible to the computer system. In addition, the computer system includes at least one output device and at least one input device.

Computer system 10 includes a bus 22 or other communication device for communicating information within computer system 10, and at least one processing device such as processor 12, coupled to bus 22 for processing information. Bus 22 preferably includes low-latency and higher latency paths that are connected by bridges and adapters and controlled within computer system 10 by multiple bus controllers. When implemented as a server system, computer system 10 typically includes multiple processors designed to improve network servicing power.

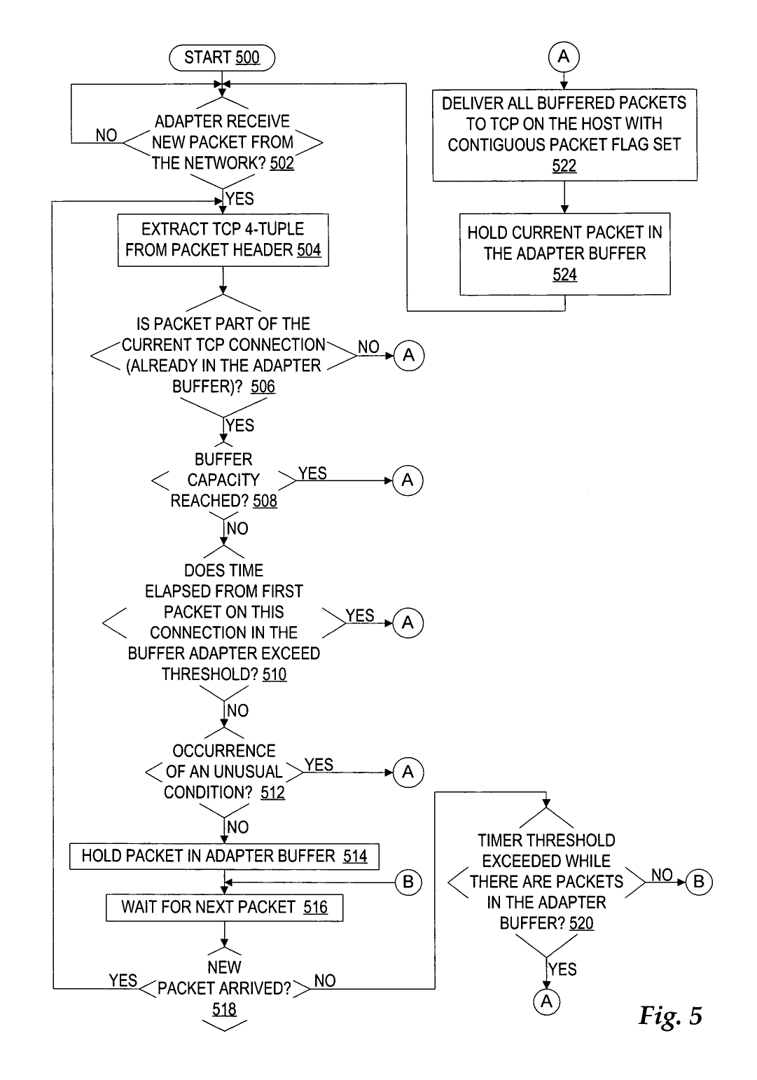

Processor 12 may be a general-purpose processor such as IBM's PowerPC™ processor that, during normal operation, processes data under the control of operating system and application software accessible from a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowchart of FIG. 5 and others described herein. Alternatively, the steps of the present invention might be performed by specific hardware components that contain hardwired logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution.

Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of a non-volatile medium is mass storage device 18 which as depicted is an internal component of computer system 10, but will be understood to also be provided by an external device. Volatile media include dynamic memory such as RAM 14. Transmission media include coaxial cables, copper wire or fiber optics, including the wires that comprise bus 22. Transmission media can also take the form of acoustic or light waves, such as those generated during radio frequency or infrared data communications.

Moreover, the present invention may be downloaded as a computer program product, wherein the program instructions may be transferred from a remote computer such as a server 40 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through network 102. Network 102 may refer to the worldwide collection of networks and gateways that use a particular protocol, such as Transmission Control Protocol (TCP) and Internet Protocol (IP), to communicate with one another. ISP 37 and network 102 both use electrical, electromagnetic, or optical signals that carry digital data streams. The signals through the various networks and the signals on network link 34 and through communication interface 32, which carry the digital data to and from computer system 10, are exemplary forms of carrier waves transporting the information.

When implemented as a server system, computer system 10 typically includes multiple communication interfaces accessible via multiple peripheral component interconnect (PCI) bus bridges connected to an input/output controller. In this manner, computer system 10 allows connections to multiple network computers.

Advantageously, communication interface 32 includes a network adapter 300, such as an Ethernet adapter, able to manage an interface between the host computer system 10 and network 102. Typically, a network adapter includes a bus interface that communicates with the I/O bus within bus 22 and a link interface that implements the correct protocol over network 102. The network adapter is preferably enabled to handle TCP and in the present invention enabled to handle the desegmentation of data segments received at computer system 10.

Further, multiple peripheral components may be added to computer system 10, connected to multiple controllers, adapters, and expansion slots coupled to one of the multiple levels of bus 22. For example, an audio input/output 28 is connectively enabled on bus 22 for controlling audio input through a microphone or other sound or lip motion capturing device and for controlling audio output through a speaker or other audio projection device. A display 24 is also connectively enabled on bus 22 for providing visual, tactile or other graphical representation formats. A keyboard 26 and cursor control device 30, such as a mouse, trackball, or cursor direction keys, are connectively enabled on bus 22 as interfaces for user inputs to computer system 10. In alternate embodiments of the present invention, additional input and output peripheral components may be added.

Those of ordinary skill in the art will appreciate that the hardware depicted in FIG. 1 may vary. Furthermore, those of ordinary skill in the art will appreciate that the depicted example is not meant to imply architectural limitations with respect to the present invention.

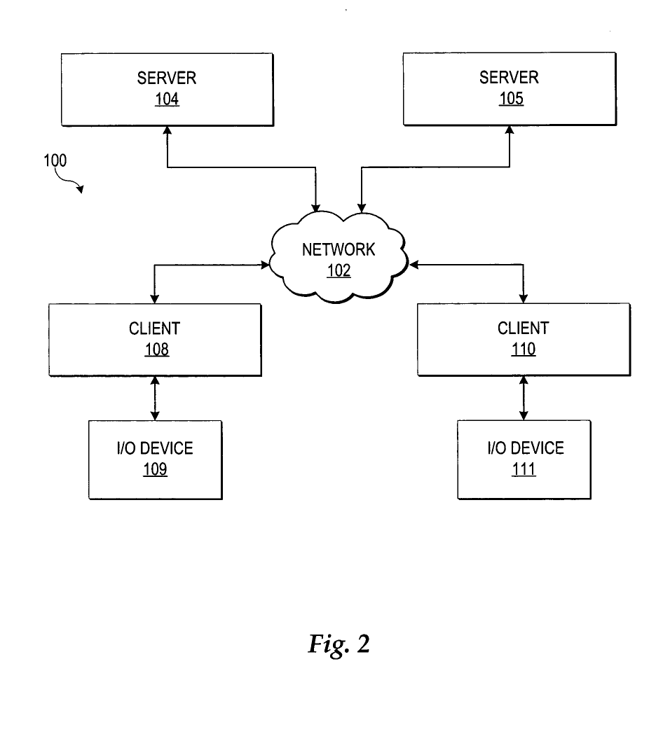

With reference now to FIG. 2, a block diagram depicts a distributed network system for transferring data packets in accordance with the method, system, and program of the present invention. Distributed data processing system 100 is a network of computers in which the present invention may be implemented. Distributed data processing system 100 contains a network 102, which is the medium used to provide communications links between various devices and computers connected together within distributed data processing system 100. Network 102 may include permanent connections such as wire or fiber optics cables, temporary connections made through telephone connections and wireless transmission connections.

In the depicted example, servers 104 and 105 are connected to network 102. In addition, clients 108 and 110 are connected to network 102 and provide a user interface through input/output (I/0) devices 109 and 111. Clients 108 and 110 may be, for example, personal computers or network computers. For purposes of this application, a network computer is any computer coupled to a network, which receives a program or other application from another computer coupled to the network.

The client/server environment of distributed data processing system 100 is implemented within many network architectures. For example, the architecture of the World Wide Web (the Web) follows a traditional client/server model environment. The terms “client” and “server” are used to refer to a computer's general role as a requester of data (the client) or provider of data (the server). In the Web environment, web browsers such as Netscape Navigator™ typically reside on client systems 108 and 110 and render Web documents (pages) served by a web server, such as servers 104 and 105. Additionally, each of client systems 108 and 110 and servers 104 and 105 may function as both a “client” and a “server” and may be implemented utilizing a computer system such as computer system 10 of FIG. 1. Further, while the present invention is described with emphasis upon servers 104 and 105 enabling downloads or communications, the present invention may also be performed by client systems 108 and 110 engaged in peer-to-peer network communications and downloading via network 102.

The Web may refer to the total set of interlinked hypertext documents residing on servers all around the world. Network 102, such as the Internet, provides an infrastructure for transmitting these hypertext documents between client systems 108 and 110 and servers 104 and 105. Documents (pages) on the Web may be written in multiple languages, such as Hypertext Markup Language (HTML) or Extensible Markup Language (XML), and identified by Uniform Resource Locators (URLs) that specify the particular web page server from among servers, such as server 104 and pathname by which a file can be accessed, and then transmitted from the particular web page server to an end user utilizing a protocol such as Hypertext Transfer Protocol (HTTP) or file-transfer protocol (FTP). Web pages may further include text, graphic images, movie files, and sounds, as well as Java applets and other small embedded software programs that execute when the user activates them by clicking on a link. In particular, multiple web pages may be linked together to form a web site. The web site is typically accessed through an organizational front web page that provides a directory to searching the rest of the web pages connected to the web site. While network 102 is described with reference to the Internet, network 102 may also operate within an intranet or other available networks.

A common protocol, such as TCP/IP, runs on each of servers 104 and 105 and clients 108 and 110 to enable communication between these devices across network 102. In particular, the TCP/IP stack is typically used for Internet based communications to breakup data messages into packets to be sent via IP and then reassemble and verify the complete messages from packets received by IP. Each packet consists of an IP header and a TCP header including addresses, ports, data length, and other information. When the TCP/IP protocol is used, the connection between devices is a TCP connection initiated when the client requests to connect with a server. The two sides engage in an exchange of messages to establish the connection. Then the TCP running on the server begins to buffer data into packet size segments to send across the TCP connection. In the present invention, the network adapter desegments the packets before sending the desegmented group of packets to the network stack. The TCP/IP stack receives each packet as is known in the art, but instead of each packet individually traversing the path from the network adapter to the TCP/IP stack, a group of packets from the same connection is sent in one pass. It will be understood that while the present invention is described with reference to TCP/IP protocol, other protocols may be implemented. For example, in lieu of TCP, other transport protocols which involve considerable latency for data transfer between adapter and network stack, such as Stream Control Transmission Protocol (SCTP), may be implemented.

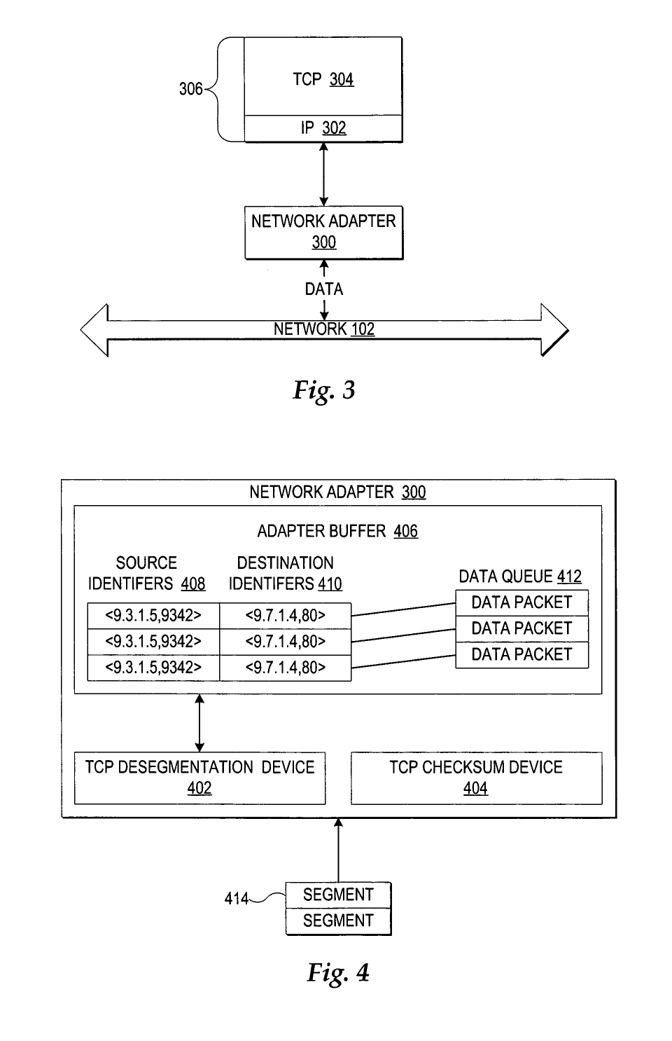

Referring now to FIG. 3, there is depicted a block diagram of a network adapter within a networking system in accordance with the method, system, and program of the present invention. As illustrated, data runs between network adapter 300 and network 102. In the example, network adapter 300 is hardware that passes data packet segments to and from a software based network protocol stack 306 within the host computer system. A typical network protocol stack includes multiple layers for handling the protocols used for passing segments across network 102. For example, network stack 306 includes an Internet Protocol (IP) layer 302 and a Transport Control Protocol (TCP) layer 304. Although not depicted, it will be understood that network stack 306 may include additional protocol layers. Additionally, although not depicted, it will be understood that additional hardware and software components, such as device drivers, may be implemented by the host computer system to implement network communications.

With reference now to FIG. 4, there is illustrated a block diagram of a network adapter for desegmenting packets in accordance with the method, system, and program of the present invention. As depicted, network adapter 300 includes a TCP desegmentation device 402, a TCP checksum device 404 and an adapter buffer 406. Data is received at network adapter in data packet segments, such as segment 414. TCP checksum device 404 of network adapter 300 preferably extracts the TCP 4-tuple from the TCP header of each segment. As previously described, a TCP connection is established between two network devices, such as a server and a client. Network adapter 300 facilitates the TCP connection by one of these two network devices. Each of the two network devices has an IP address and a port number. The TCP 4-tuple identifies the TCP connection by the IP address and port number for each of the two network devices. In particular, the connection identifiers for the TCP 4-tuple include the following components: source IP address (src-ip), source port number (src-port), destination IP address (dst-ip), and destination port number (dst-port). Typically, each of the addresses and ports are expressed as a numeral.

TCP checksum device 404 calculates a checksum for each data packet segment and compares the currently calculated sum with the checksum included in the TCP header of each segment. If the checksum is not valid, then a checksum failure will be returned for the segment.

TCP desegmentation device 402 uses the TCP 4-tuple to decide which segments to buffer in adapter buffer 406. TCP desegmentation device 402 compares the IP addresses and port numbers for each data packet segment with the IP addresses and port numbers of the data packets stored in adapter buffer 406 at source identifiers 408 and destination identifiers 410.

Adapter buffer 406 preferably stores the source identifiers 408, destination identifiers 410 and data packets in a data queue 412 for data packet segments received from the same TCP connection. Then, if the source identifiers and destination identifiers of a newly received data packet segment match source identifiers 408 and destination identifiers 410, the newly received data packet is added to data queue 412. By adding the newly received matching data packet to the queue, multiple data packet segments received from the same TCP connection are desegmented by being placed into a group to be transferred together for processing. In particular, in the example depicted for source identifiers 408 and destination identifiers 410, the IP address is specified first, separated from the port address by a “,”.

Once a particular condition is reached, the TCP desegmentation device will send the data packets stored in adapter buffer 406 to the host stack in a single traversal with a flag indicating the data packets can be processed as a group. A first condition causing the group to be sent up to the host stack is when the newly received data packet segment does not match the TCP connection of the data packets segments in adapter buffer 406. A second condition causing the group to be sent up to the host stack is when the adapter buffer is full. A third condition causing the group to be sent up to the host stack is when the time the first packet for the TCP connection has been held in adapter buffer 406 exceeds a threshold time. In particular, a timer is preferably started by TCP desegmentation device 402 when the first data packet for a new TCP connection is placed in adapter buffer 406. Advantageously, the time threshold may be adjusted through software in order to achieve the most efficient flow of data through network adapter 300. Additionally, a fourth condition causing the group to be sent up to the host stack is when an abnormal condition occurs. For example, TCP desegmentation device 402 may detect an abnormal condition if there is a checksum mismatch, the connection is reset, an urgent pointer is received, or a missing packet is detected.

By adapter 300 sending data packet from the same TCP connection together as a desegmented group to be processed together, increased efficiency is achieved in the processing operations of the host computer system. Even if only five packets are queued in adapter buffer 406 and sent together for processing, the incoming packet processing code is executed for the network stack 80% less often than if data packet segments are processed individually. Efficiency is further gained where, for example, a single direct memory access (DMA) is performed for the grouped packets to a contiguous memory block, instead of performing a DMA for each individual data packet. In another example, receipt of the group of data packets in the translation lookaside buffer (TLB) enhances the efficiency of the TLB in holding the data most likely to be next requested because a group of related data packets is received in the TLB. In yet another example, the number of protocol control block (PCB) searches is reduced at the protocol level since a PCB search is only required to be performed once for the desegmented group of data packets, rather than for each data packet.

Referring now to FIG. 5, there is depicted a high level logic flowchart of a process and program for desegmenting data packets at a network adapter. As illustrated, the process starts at block 500 and thereafter proceeds to block 502. Block 502 depicts a determination whether an adapter receives a new data packet from the network. If a new data packet is not received, the process iterates at block 502. When a new data packet is received, the process passes to block 504. Block 504 depicts extracting the 4-tuple from the packet header, and the process passes to block 506.

Block 506 depicts a determination whether the packet is part of the current TCP connection. In particular, there is a determination whether the packet matches the other data stored in the adapter buffer. If the packet is not part of the current TCP connection, then the 20 process passes to block 522, described below. If the packet is part of the current TCP connection, then the process passes to block 508.

Block 508 depicts a determination whether the buffer capacity is reached. If the buffer capacity is reached, then the process passes to block 522. If the buffer capacity is not yet reached, then the process passes to block 510.

Block 510 depicts a determination whether the time elapsed from the first packet on the connection in the buffer adapter exceeds a threshold time. If the time elapsed exceeds a threshold time, then the process passes to block 522. If the time elapsed does not exceed a threshold time, then the process passes to block 512.

Block 512 depicts a determination whether there is the occurrence of an unusual condition. For example, receiving a reset, checksum failure or other signal indicating an irregularity may qualify as the occurrence of an unusual condition. If there is an occurrence of an unusual condition, then the process passes to block 522. If there is not an occurrence of an unusual condition, then the process passes to block 514.

Block 514 depicts holding the packet in the adapter buffer. Next, block 516 illustrates waiting for the next packet. Thereafter, block 518 depicts a determination whether a new packet has arrived. If a new packet arrives, then the process passes to block 504. If a new packet has not arrived, then the process passes to block 520. Block 520 depicts a determination whether the timer threshold is exceeded while there are packets in the adapter buffer. If the timer threshold is not exceeded, then the process returns to block 516. If the timer threshold is exceeded, then the process passes to block 522.

Block 522 depicts delivering all the buffered packets to the TCP/IP stack on the host with a contiguous packet flag set. Next, block 524 depicts holding the current packet in the adapter buffer to wait for additional packets from the same connection as the current packet, and the process passes to block 502.

While the invention has been particularly shown and described with reference to a preferred embodiment, it will be understood by those skilled in the art that various changes in form and detail may be made therein without departing from the spirit and scope of the invention.

1. A method for efficient packet desegmentation on a network adapter, comprising:
buffering a plurality of data packet segments received at a network adapter from a single connection, wherein said single connection is identified by a plurality of addresses and ports extracted from each header of each of said plurality of data packet segments; and
responsive to detecting a buffering release condition, releasing said plurality of data packet segments from said network adapter as a desegmented group to a network stack, such that data packets segments received from said single connection are efficiently passed to said network stack together.

2. The method according to claim 1 for efficient packet desegmentation further comprising:
responsive to receiving a new data packet segment at said network adapter, extracting a plurality of addresses and ports for a connection across which said new data packet segment was sent;
responsive to said plurality of addresses and ports for said connection matching a buffered plurality of addresses and ports for said single connection, buffering said new data segment at said network adapter with said plurality of data packet segments previously buffered.

3. The method according to claim 1 for efficient packet desegmentation wherein said single connection is a TCP connection identified by a four-tuple of source and destination addresses and ports extracted from each TCP header of each of said plurality of data packet segments.

4. The method according to claim 1 for efficient packet desegmentation further comprising:
detecting said buffering release condition when a new data packet segment received at said network adapter is from a different connection than said single connection.

5. The method according to claim 1 for efficient packet desegmentation further comprising:
detecting said buffering release condition when a time a first receiving data packet segment from among said plurality of data packet segments is buffered at said network adapter exceeds a time threshold.

6. The method according to claim 1 for efficient packet desegmentation further comprising:
detecting said buffering release condition when a queue size limit in said network adapter for buffering data packet segments is reached.

7. The method according to claim 1 for efficient packet desegmentation further comprising:
detecting said buffering release condition when an abnormal condition occurs, wherein said abnormal condition is at least one from among a checksum mismatch, a connection reset, an urgent pointer, and a missing packet being detected.

8. A system for efficient packet desegmentation on a network adapter, comprising:
a network adapter with an interface for facilitating transfer of data packets between a data processing system and a network;
said network adapter further comprising:
a buffer for buffering a plurality of data packet segments received at said network adapter from a single connection across said network, wherein said single connection is identified by a plurality of addresses and ports extracted from each header of each of said plurality of data packet segments; and
a desegmenting means for releasing said plurality of data packet segments from said buffer together in a desegmented group to a network stack in said data processing system, responsive to detecting a buffering release condition.

9. The system according to claim 8 for efficient packet desegmentation, said desegmenting means further comprising:
means, responsive to receiving a new data packet segment at said network adapter, for extracting a plurality of addresses and ports for a connection across which said new data packet segment was sent;
means, responsive to said plurality of address and ports for said connection matching a buffered plurality of addresses and ports for said single connection, for buffering said new data segment in said buffer.

10. The system according to claim 8 for efficient packet desegmentation wherein said single connection is a TCP connection identified by a four-tuple of source and destination addresses and ports extracted from each TCP header of each of said plurality of data packet segments.

11. The system according to claim 8 for efficient packet desegmentation, said desegmenting means further comprising:
means for detecting said buffering release condition when a new data packet segment received at said network adapter is from a different connection than said single connection.

12. The system according to claim 8 for efficient packet desegmentation, said desegmenting means further comprising:
means for detecting said buffering release condition when a time a first receiving data packet segment from among said plurality of data packet segments remains within said buffer exceeds a time threshold.

13. The system according to claim 8 for efficient packet desegmentation, said desegmenting means further comprising:
means for detecting said buffering release condition when a queue size limit in said buffer is reached.

14. The system according to claim 8 for efficient packet desegmentation, said desegmenting means further comprising:
means for detecting said buffering release condition when an abnormal condition occurs, wherein said abnormal condition is at least one from among a checksum mismatch, a connection reset, an urgent pointer, and a missing packet being detected.

15. A computer program product for efficient packet desegmentation on a network adapter, comprising:
a recording medium;
means, recorded on said recording medium, for buffering a plurality of data packet segments received at a network adapter from a single connection, wherein said single connection is identified by a plurality of addresses and ports extracted from each header of each of said plurality of data packet segments; and
means, recorded on said recording medium, for releasing said plurality of data packet segments from said network adapter in a single desegmented group to a network stack, responsive to detecting a buffering release condition.

16. The computer program product according to claim 15 for efficient packet desegmentation further comprising:
means, recorded on said recording medium, for extracting a plurality of addresses and ports for a connection across which said new data packet segment was sent, responsive to receiving a new data packet segment at said network adapter;
means, recorded on said recording medium, for buffering said new data segment at said network adapter with said plurality of data packet segments previously buffered, responsive to said plurality of addresses and ports for said connection matching a buffered plurality of addresses and ports for said single connection.

17. The computer program product according to claim 15 for efficient packet desegmentation further comprising:
means, recorded on said recording medium, for detecting said buffering release condition when a new data packet segment received at said network adapter is from a different connection than said single connection.

18. The computer program product according to claim 15 for efficient packet desegmentation further comprising:
means, recorded on said recording medium, for detecting said buffering release condition when a time a first receiving data packet segment from among said plurality of data packet segments is buffered at said network adapter exceeds a time threshold.

19. The computer program product according to claim 15 for efficient packet desegmentation further comprising:
means, recorded on said recording medium, for detecting said buffering release condition when a queue size limit in said network adapter for buffering data packet segments is reached.

20. The computer program product according to claim 15 for efficient packet desegmentation further comprising:
means, recorded on said recording medium, for detecting said buffering release condition when an abnormal condition occurs, wherein said abnormal condition is at least one from among a checksum mismatch, a connection reset, an urgent pointer, and a missing packet being detected.
